(19) United States
(12) Patent Application Publication
(10) Pub. No.: US 2025/0001376 A1
(43) Pub. Date: Jan. 2, 2025

(54) METHOD OF DETERMINING DEGREE OF MIXING OF PARTICLES OF INTEREST, NON-TRANSITORY COMPUTER-READABLE RECORDING MEDIUM HAVING STORED THEREIN PROGRAM FOR DETERMINING DEGREE OF MIXING OF PARTICLES OF INTEREST,INFORMATION PROCESSING APPARATUS, AND MIXER

(71) Applicant: TOHOKU UNIVERSITY, Sendai-shi (JP)

(72) Inventors: Kizuku KUSHIMOTO, Sendai-shi (JP); Junya KANO, Sendai-shi (JP)

(73) Assignee: TOHOKU UNIVERSITY, Sendai-shi (JP)

(21) Appl. No.: 18/884,521

(22) Filed: Sep. 13, 2024

Related U.S. Application Data
(63) Continuation of application No. PCT/JP2022/011448, filed on Mar. 14, 2022.

(51) Int. Cl. B01F 35/213; G01N 15/0205

(52) U.S. Cl. CPC B01F 35/213; G01N 15/0205

(57) ABSTRACT

A computer-implemented method of determining a degree of mixing of particles of interest includes, for determining the degree of mixing of the particles of interest from a mixture containing the particles of interest, calculating and determining a size to be sampled from the mixture based on a relationship formula between a total size of the mixture and a size per particle of interest.

### CROSS-REFERENCE TO RELATED APPLICATION

This application is a continuation application of International Application PCT/JP2022/011448 filed on Mar. 14, 2022, and designated the U.S., the entire contents of which are incorporated herein by reference.

### FIELD

The embodiments discussed herein are related to a method of determining a degree of mixing of particles of interest, a non-transitory computer-readable recording medium having stored therein program for determining a degree of mixing of particles of interest, an information processing apparatus, and a mixer.

### BACKGROUND

In many industrial fields such as pharmaceuticals, food, ceramics, and powder metallurgy, mixing operations are performed to mix two or more various types of particles during the manufacturing process of products.

The mixing state of a mixture achieved through mixing operations affects the quality of the final product including the mixture as a constituting element. Therefore, the mixing state is evaluated based on the degree of mixing, which numerically indicates the degree of mixing of particles of interest in the mixture, to determine whether the desired mixing state has been reached. The degree of mixing is calculated by measuring a portion (sample) taken (sampled) from the mixture containing the particles of interest.

Methods of measuring the sample include direct measurement of the sample per se, as well as measurement of the properties thereof, such as electrical and magnetic, surface, physicochemical, and mechanical properties (Non-patent Document 1).

One related known method is Lacey's Mixing Index that expresses the degree of mixing by comparing the statistical variance of measurement data against the statistical variances of the random state and the separated state (Non-patent Documents 2 and 3).

Furthermore, a method is known for determining the minimum number of particles required by logarithmic calculations to keep the error within a given range at a given confidence level in powdered materials, where the sampling amount (number of particles) and relative error follow log-normal distributions (Non-patent Document 4).

### RELATED ART DOCUMENTS

### Non-Patent Documents

[Non-patent Document 1] Etsuo Yonemochi, Mixing Process and Blend Uniformity of Pharmaceutical Powders, Journal of Pharmaceutical Science and Technology, Japan, Vol. 64(5), 302-304 (2004).
[Non-patent Document 2] Yoichi Nakata et al., Quantitative Evaluation of Mixed States of Granular Systems with Shannon Entropy, J. Soc. Powder Technol., Japan, 54, 296-304 (2017).
[Non-patent Document 3] P. M. C. Lacey's et al., The Mixing of Solid Particles, Transactions of the Institution of Chemical Engineers, Vol. 21, 53-59 (1943)
[Non-patent Document 4] Setsu Sakashita, “Fundamentals of Powder Technology” for Color Material Engineers, J. Jpn Soc. Colour Mater., 78(11), 520-530 (2005)

### SUMMARY

Although the degree of mixing is a statistically based quantitative indicator, the reality is that the conditions for sampling a portion of the mixture are difficult to specify and are often determined based on empirical rules. Therefore, it is desired to appropriately determine sampling conditions based on logical grounds to maintain the reliability of the degree of mixing.

In one aspect, one object of the present disclosure is to eliminate unnecessary sampling efforts while maintaining the reliability of the degree of mixing by determining the conditions for sampling to measure the degree of mixing of particles of interest in a mixture based on logical grounds, to thereby improve the accuracy of quality control for the final product including the mixture as a constituting element, making it optimal.

The method of determining a degree of mixing of particles of interest disclosed herein includes, for determining the degree of mixing of the particles of interest from a mixture containing the particles of interest, calculating and determining a size to be sampled from the mixture based on a relationship formula between a total size of the mixture and a size per particle of interest.

### Advantageous Effect

In one aspect, the present disclosure can improve the accuracy of quality control for the final product including the mixture as a constituting element by appropriately determining the conditions for sampling to measure the degree of mixing of particles of interest in the mixture.

The object and advantages of the disclosure will be realized and attained by means of the elements and combinations particularly pointed out in the claims.

It is to be understood that both the foregoing general description and the following detailed description are exemplary and explanatory and are not restrictive of the disclosure, as claimed.

### BRIEF DESCRIPTION OF THE DRAWINGS

FIG. 1 is a diagram for describing an example of mixing two types of particles with a mixer (rolling rotary mixer).

FIG. 2A is a diagram for describing the difference in sampling volume and the completely separated state. FIG. 2B is a diagram for describing the difference in sampling volume and the completely mixed state.

FIG. 3A is a diagram illustrating the degree of mixing when the sampling volume is optimal, FIG. 3B is a diagram illustrating the degree of mixing when the sampling volume is small, and FIG. 3C is a diagram illustrating the degree of mixing when the sampling volume is large.

FIG. 4 is a diagram for describing the definition of the completely separated state.

FIG. 5A is a diagram for describing the definition of the completely mixed state, and FIG. 5B is a diagram illustrating the extraction model.

FIG. 6A is a graph when the allowable range Rᵥ is 0.01, and FIG. 6B is a graph when the allowable range Rᵥ is 0.2.

FIG. 7A is a diagram for describing the case when the number of samplings is large. FIG. 7B is a diagram for describing the case when the number of samplings is small.

FIG. 8A is a diagram illustrating the degree of mixing when the number of samplings is large, FIG. 8B is a diagram illustrating the degree of mixing when the number of samplings is small, and FIG. 8C is a diagram illustrating the degree of mixing when the number of samplings is optimal.

FIG. 9 is a block diagram schematically illustrating an example of the hardware configuration of an information processing apparatus according to an embodiment.

FIG. 10 is a block diagram schematically illustrating an example of the software functional configuration of the information processing apparatus according to an embodiment.

FIG. 11 is a flowchart for describing an operation example of the process for determining the degree of mixing of particles of interest according to an embodiment.

FIG. 12 is a block diagram schematically illustrating an example of the hardware configuration of a mixer according to an embodiment.

### DETAILED DESCRIPTION OF EMBODIMENT(S)

Hereinafter, an embodiment of the present disclosure will be described with reference to the drawings. In the drawings used in the following embodiment, elements denoted by the same reference numerals denote the same or like elements unless otherwise specified.

An information processing apparatus and a mixer (rolling rotary mixer) that determine the degree of mixing of particles of interest from a mixture containing the particles of interest according to the present embodiment are achieved by a method and a program that cause a computer to execute the above-mentioned determination process.

As will be described later, the size of the particles of interest according to the present embodiment refers to the magnitude of the particles of interest occupied in the mixture. Depending on the information obtained from the target mixture, the size can be volume, area, length, or number.

### [1] Problem with Sampling Conditions

As discussed above, the degree of mixing is a quantitative indicator representing the degree of mixing of particles of interest in a mixture and the degree of mixing is calculated by measuring a portion (sample) taken (sampled) from the mixture. In general, the degree of mixing M can be expressed by Formula 1.

$$\begin{matrix}[ Expression 1 ] & \\ M = 1 - \frac{σ}{{σ}_{0}} & ( Formula 1 )\end{matrix}$$

The variables on the right side of Formula 1 are as follows: σ is the standard deviation of the sample and σ₀ is the standard deviation in the completely separated state (the standard deviation when the entire mixture is sampled with an infinitely small sample size from the completely separated state). The standard deviation of the sample is calculated by Formula 2.

$$\begin{matrix}[ Expression 2 ] & \\ σ = \frac{{\sum }_{i = 1}^{{N}_{\text{?}}} {( {C}_{i} - P )}^{2}}{N \text{?}} & ( Formula 2 )\end{matrix}$$

$$\text{?} \text{indicates text missing or illegible when filed}$$

The variables on the right side of Formula 2 are as follows: Nₛ is the number of samplings, Cᵢ is the proportion of the particles of interest in the sampling volume, and P is the proportion of the particles of interest in the total volume V of the mixture. The number of samplings is the number of times samples are taken. The sampling volume refers to the sampling unit per sample and can be an area, length, number, or other unit besides volume.

It can be understood from Formula 2 that the sampling volume and the number of samplings are parameters of the sampling conditions and affect the degree of mixing, but the reality is that these values are determined based on empirical rules.

Therefore, in the present embodiment, a description will be made on a method of determining the sampling size and the number of samplings, which are the sampling conditions, according to the desired degree of mixing, in the process of determining the degree of mixing of the particles of interest.

### [2] Determination of Sampling Volume

Hereinafter, the case where the size is volume will be explained as an example for ease of understanding. The relationship between the sampling volume and the degree of mixing is discussed in Section [2-1], the relationship between the sampling volume and the degree of mixing in the completely separated state is discussed in Section [2-2], and the relationship between the sampling volume and the degree of mixing in the completely mixed state is discussed in Section [2-3]. Furthermore, the method of determining the optimal sampling volume is discussed in Section [2-4], and the expansion of the allowable range of the sampling volume is discussed in Section [2-5].

In the following description, the case where the mixer is a rolling rotary mixer for mixing two types of particles in equal numbers will be used as an example for ease of understanding, but the scope of application of the present disclosure is not limited to this form. As long as the particles of interest are solid of which particle size can be specified, other particles or media in the target particles are not limited to solid and may be liquid or gas. Furthermore, if the particles of interest form an aggregate that is crushed or otherwise processed in a rotary mixer, they can be used as long as the size (volume, area, length, or number) of the particles of interest to measure the degree of mixing is known. The shape of the particles is not limited as long as the size of the particles of interest is known. In addition, the ratio of the number, amount, etc. of particles of interest to other particles is not limited to the example used in the description, and any ratio can be applied. Furthermore, the mixing is not necessarily performed by the rolling rotary mixer and any known mixing method can be applied.

### [2-1] Relationship Between Sampling Volume and Degree of Mixing

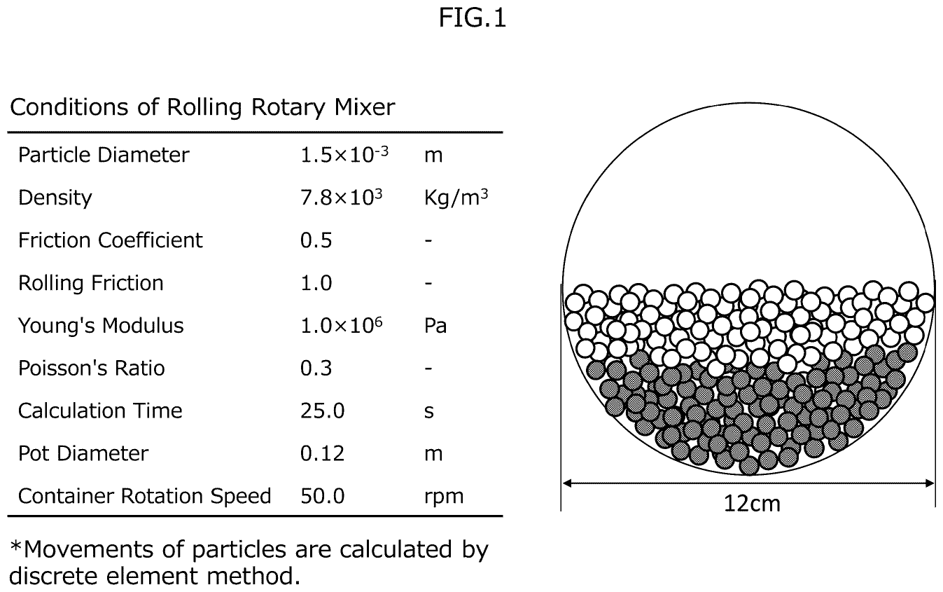

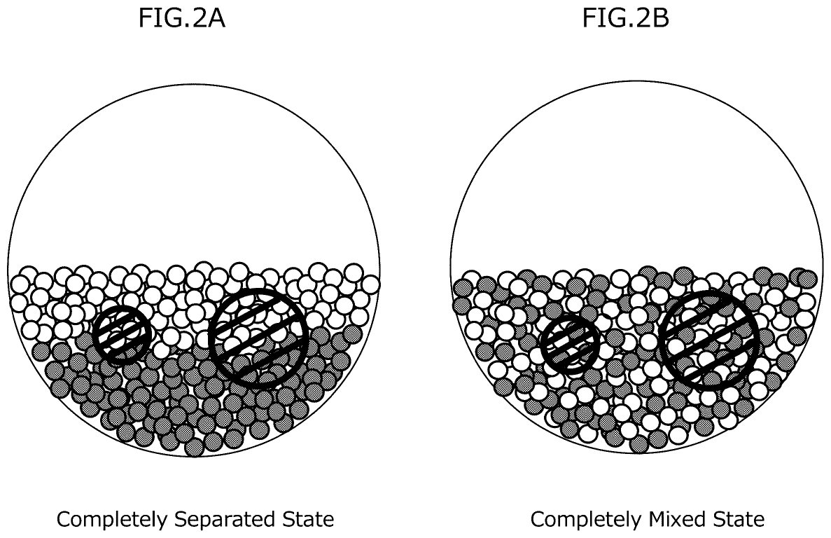

First, the relationship between the sampling volume and the degree of mixing will be described. As illustrated in FIG. 1, an example of mixing two types of particles with a rolling rotary mixer is considered (see FIG. 1 for the conditions of the rolling rotary mixer). The particles have two colors, namely, black and white, the volume per particle is the same, the number of particles of each color is the same in this example, and the particles of interest are white particles. During the mixing process, the particles of interest change from the completely unmixed state (completely separated state) before mixing illustrated in FIG. 2A to the state where the particles of interest are uniformly mixed (completely mixed state) illustrated in FIG. 2B. The hatched black circles in the particle group represent the sampling units per sample, with small black circles representing small volumes and large black circles representing large volumes.

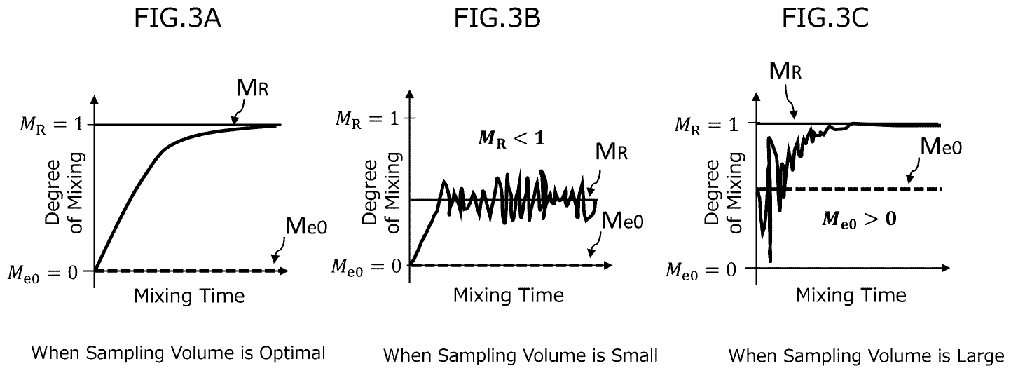

FIGS. 3A to 3C are graphs with the horizontal axis representing mixing time and the vertical axis representing the degree of mixing M, with the thick solid line representing the degree of mixing M calculated based on Formulas 1 and 2 using samples taken at each time. The degree of mixing takes a value between 0 and 1, and variables on the vertical axis are as follows: Mₑ₀ is the degree of mixing in the completely separated state and M_{R} is the degree of mixing in the completely mixed state. Two horizontal lines are drawn in each graph, with the dashed line representing the degree of mixing Mₑ₀ and the solid line representing the degree of mixing M_{R}.

When the sampling volume v is optimal, as illustrated in FIG. 3A, the degree of mixing M is drawn as a single curve extending from the completely separated state to the completely mixed state, and the degree of mixing can be measured from 0 to 1. However, when the sampling volume v is relatively small, as illustrated in FIG. 3B, the maximum measurable degree of mixing is reduced and the degree of mixing may be thus underestimated compared to the actual mixing state. When the sampling volume v is relatively large, as illustrated in FIG. 3C, the value of the degree of mixing at the start of mixing is greater than 0, and the state at the start of mixing and the state immediately after the start of mixing where mixing has not progressed cannot be accurately measured.

Here, noting the width between the degree of mixing Mₑ₀ in the completely separated state and the degree of mixing M_{R} in the completely mixed state, the sum of the error from 0 in the completely separated state Mₑ₀ and the error from 1 in the completely mixed state M_{R} (hereinafter also referred to as “error of the degree of mixing”) D_{M} can be expressed by the sum of the completely separated state Mₑ₀ and the completely mixed state M_{R} as Formula 3.

$$\begin{matrix}[ Expression 3 ] & \\ {D}_{M} = 1 - {M}_{R} + {M}_{e 0} & ( Formula 3 )\end{matrix}$$

It can be understood from Formula 3 that when the sum of the error from 0 in the completely separated state Mₑ₀ and the error from 1 in the completely mixed state M_{R} is minimized, the error of the degree of mixing D_{M} is minimized, and in this case, the sampling volume v becomes optimal. Therefore, if the relationships of the degree of mixing Mₑ₀ in the completely separated state and the degree of mixing M_{R} in the completely mixed state to the sampling volume v can be expressed as respective functions, the optimal sampling volume vₒₚₜ can be calculated.

### [2-2] Relationship Between Sampling Volume and Degree of Mixing in Completely Separated State

The degree of mixing Mₑ₀ in the completely separated state is expressed by Formula 4 from the definition of Formula 1.

$$\begin{matrix}[ Expression 4 ] & \\ {M}_{e 0} = 1 - \frac{{σ}_{e 0}}{{σ}_{0}} & ( Formula 4 )\end{matrix}$$

The variables on the right side of Formula 4 are as follows: σₑ₀ is the standard deviation of the sample in the completely separated state and σ₀ is the standard deviation in the completely separated state (the standard deviation when the entire mixture is sampled with an infinitely small sample size from the completely separated state).

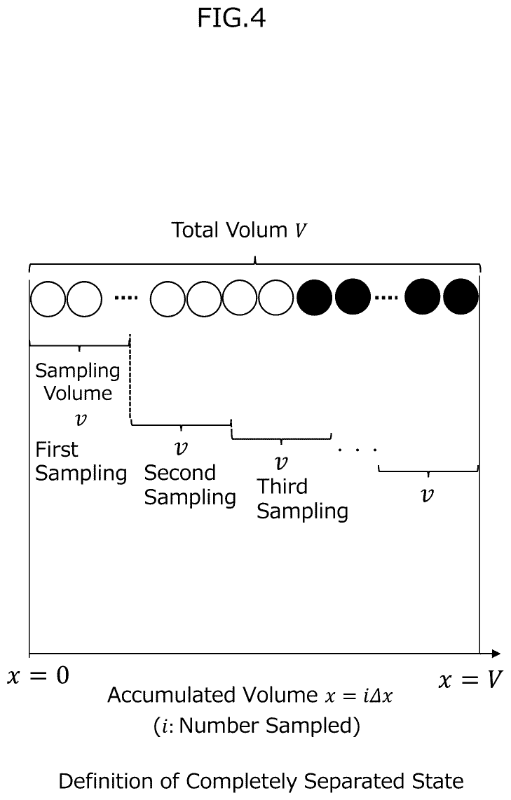

First, the standard deviation σₑ₀ of the sample in the completely separated state will be calculated. Here, referring to FIG. 4, the definition of the completely separated state is described using white and black particles as an example. FIG. 4 is a diagram illustrating the completely separated state as a one-dimensional representation where all particles are divided into white and black particles and arranged in a horizontal line. The horizontal axis represents the cumulative volume, and adjacent particles are in contact at one point.

Assuming that the sampling volume v is the volume of, for example, three particles, and all particles are sampled from left to right. (When the sampling volume v is not a factor of the total particle volume, the remainder can be ignored if the total particle volume V is sufficiently large.) The standard deviation σₑ₀ of the proportion Cᵢ of the particles of interest in the particle groups sampled up to the maximum number N_{s,max} times with respect to the population mean P is expressed by Formula 5 from the definition of Formula 2.

$$\begin{matrix}[ Expression 5 ] & \\ {σ}_{e 0} = \sqrt{\frac{{\sum }_{i = 1}^{{N}_{s , max}} {( {C}_{i} - P )}^{2}}{{N}_{s , max}}} & ( Formula 5 )\end{matrix}$$

The variables on the right side of Formula 5 are as follows: N_{s,max} is the maximum number of samplings, Cᵢ is the proportion of the particles of interest in the sampling volume, and P is the proportion of the particles of interest in the total volume V of the mixture.

The maximum number of samplings N_{s,max} is expressed by Formula 6. The variables on the right side of Formula 6 are as follows: V is the total volume and v is the sampling volume.

$$\begin{matrix}[ Expression 6 ] & \\ {N}_{s , max} = \frac{V}{v} & ( Formula 6 )\end{matrix}$$

The proportion Cᵢ of the particles of interest in the sampling volume of the i^{th} sampling takes the value in the range of Formula 7.

$$\begin{matrix}[ Expression 7 ] & \\ {C}_{i} = \{ \begin{matrix}1 & ( i \leq t ) \\ P & ( i = t + 1 ) \\ 0 & ( i \geq t + 2 )\end{matrix} [ t = \frac{VP - vP}{v} ] & ( Formula 7 )\end{matrix}$$

Formula 5 for calculating the standard deviation σₑ₀ of the proportion Cᵢ of the particles of interest in the sampling volume of the particle groups sampled up to the maximum number N_{s,max} with respect to the population mean P has been described. Applying Formulas 6 and 7 to this Formula 5 gives Formula 8. Formula 8 is one example of the standard deviation σₑ₀ used as the degree of mixing Mₑ₀ in the completely separated state. As described above, the standard deviation σₑ₀ used as the degree of mixing Mₑ₀ in the completely separated state is the standard deviation when any entire mixture is divided by the sampling volume and the number of samplings is maximized.

$$\begin{matrix}[ Expression 8 ] & \\ {σ}_{e 0} = \sqrt{{P}^{2} + \frac{( 1 - 2 P ) t - 2 {P}^{2}}{{N}_{s , max}}} = \sqrt{P ( 1 - P ( 1 - \frac{v}{V} )} & ( Formula 8 )\end{matrix}$$

Next, the standard deviation σ₀ in the completely separated state when the sampling volume v is very small compared to the total volume V is calculated. When σₑ₀ is defined as the standard deviation σₑ₀|_{v→0} when v→0 in the completely separated state, σ₀ is expressed in Formula 9.

$$\begin{matrix}[ Expression 9 ] & \\ {{σ}_{0} = {σ}_{e 0} \vert}_{v \to 0} = \sqrt{P ( 1 - P )} & ( Formula 9 )\end{matrix}$$

Substituting the standard deviation calculated from Formula 8 and the standard deviation σ₀ calculated from Formula 9 into Formula 4 for calculating the degree of mixing Mₑ₀ in the completely separated state gives Formula 10.

$$\begin{matrix}[ Expression 10 ] & \\ {M}_{e 0} = 1 - \frac{{σ}_{e 0}}{{σ}_{0}} = 1 - \frac{\sqrt{P ( 1 - P ) ( 1 - \frac{v}{V} )}}{\sqrt{P ( 1 - P )}} = 1 - \sqrt{( 1 - \frac{v}{V} )} & ( Formula 10 )\end{matrix}$$

As expressed in Formula 10, the degree of mixing Mₑ₀ in the completely separated state can be expressed only by the sampling volume v and the total volume V. The total volume is a measurable value, and only the sampling volume v is unknown.

### [2-3] Relationship Between Sampling Volume and Degree of Mixing in Completely Mixed State

The degree of mixing M_{R} in the completely mixed state is expressed by Formula 11 from the definition of Formula 1.

$$\begin{matrix}[ Expression 11 ] & \\ {M}_{R} = 1 - \frac{{σ}_{R}}{{σ}_{0}} & ( Formula 11 )\end{matrix}$$

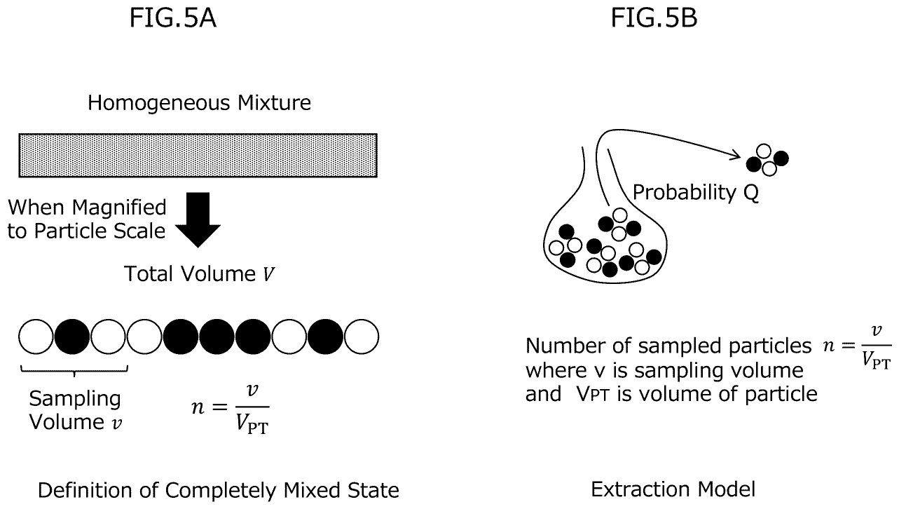

The standard deviation σ_{R} of the sample in the completely mixed state will be calculated. Here, referring to FIG. 5A, the definition of the completely mixed state is described using white and black particles as an example. FIG. 5A represents the completely mixed state as a homogeneous mixture, enlarged to the particle scale, and represented one-dimensionally by the random horizontal arrangement of all particles. As in FIG. 4, adjacent particles are in contact at one point.

Assuming that the sampling volume v is the volume of, for example, three particles, and the standard deviation when all particles are sampled randomly with the sampling volume v is σ_{R}. In the extraction model illustrated in FIG. 5B, the standard deviation σ_{R} can be considered as the standard deviation of the proportion of the particles of interest in a given volume sampled randomly taken from a bag, where the particles of interest is present with a given probability Q. Replacing this with the example of the present embodiment, the standard deviation σ_{R} can be considered to be the standard deviation of the proportion Cᵢ of the particles of interest in the sampling volume v when the sampling volume v is taken randomly from the volume V of the mixture where the particles of interest is present with a given probability P. The standard deviation σ_{R} is expressed by Formula 12 because the binomial distribution Bin(n, P) can be approximated by the normal distribution N(nP, nP(1−P)) when n>>1, nP>>1, nP(1−P)>>1. Since the total number of particles is sufficiently large, the number of random samplings is maximized.

$$\begin{matrix}[ Expression 12 ] & \\ {σ}_{R} = \sqrt{\frac{P ( 1 - P )}{n}} [ n = \frac{v}{{V}_{PT}} ] & ( Formula 12 )\end{matrix}$$

The variable on the right side of the formula for the standard deviation σ_{R} in Formula 12 is as follows: n is the number of sampled particles, and the variable on the right side of the formula for n is as follows: V_{PT} is the volume per particle of interest.

By adding a finite population correction to Formula 12, it can be transformed into the center expression of Formula 13. Formula 12 is one example of the standard deviation σ_{R} used as the degree of mixing M_{R} in the completely mixed state. As described above, the standard deviation σ_{R} used as the degree of mixing M_{R} in the completely mixed state is the standard deviation when any entire mixture is divided by the sampling volume and the number of samplings is maximized.

$$\begin{matrix}[ Expression 13 ] & \\ {σ}_{R} = \sqrt{\frac{N - n}{N - 1} \frac{P ( 1 - P )}{n}} = \sqrt{\frac{V - v}{V - {V}_{PT}} \frac{P ( 1 - P ) {V}_{PT}}{v}} & ( Formula 13 )\end{matrix}$$

In the extraction model of FIG. 5B, the randomly extracted samples are not returned to the bag, and the number of particles in the bag continues to decrease. This is a non-replacement extraction from a finite population, and adding a finite population correction to the center expression of Formula 13 results in the right-hand side expression of Formula 13.

Substituting the standard deviation σ_{R} calculated from Formula 13 and the standard deviation σ₀ calculated from Formula 9 into Formula 11 for calculating the degree of mixing M_{R} in the completely mixed state gives Formula 14.

$$\begin{matrix}[ Expression 14 ] & \\ {M}_{R} = 1 - \frac{{σ}_{R}}{{σ}_{0}} = 1 - \frac{\sqrt{\frac{V - v}{V - {V}_{PT}} \frac{P ( 1 - P ) {V}_{PT}}{v}}}{\sqrt{P ( 1 - P )}} = 1 - \sqrt{\frac{V - v}{V - {V}_{PT}} \frac{{V}_{PT}}{v}} & ( Formula 14 )\end{matrix}$$

As expressed in Formula 14, the degree of mixing M_{R} in the completely mixed state can be expressed only by the sampling volume v, the total volume V, and the volume per particle V_{PT}. The total volume and the volume per particle are measurable values, and only the sampling volume v is unknown.

### [2-4] Method of Determining Optimal Sampling Volume

As described above, the sampling volume becomes optimal when the error of the degree of mixing D_{M} is minimized. Hence, a method of determining the sampling volume (size) that minimizes the sum of the error from 0 in the completely separated state Mₑ₀ and the error from 1 in the completely mixed state M_{R} will be explained.

Establishing Formula 15 by differentiating Formula 3, and substituting the degree of mixing Mₑ₀ in the completely separated state calculated from Formula 10 and the degree of mixing M_{R} in the completely mixed state calculated from Formula 14 into Formula 15 and making calculation gives Formula 16 for calculating the optimal sampling volume v_{OPT}.

$$\begin{matrix}[ Expression 15 ] & \\ \frac{\partial }{\partial v} ( 1 - {M}_{R} + {M}_{e 0} ) = 0 & ( Formula 15 )\end{matrix}$$

$$\begin{matrix}[ Expression 16 ] & \\ {v}_{OPT} = {V ( \frac{{V}_{PT}}{V - {V}_{PT}} )}^{\frac{1}{3}} & ( Formula 16 )\end{matrix}$$

As expressed in Formula 16, the optimal sampling volume v_{OPT} can be expressed only by the total volume V and the volume per particle V_{PT}, both of which are measurable values. Therefore, the optimal sampling volume v_{OPT} can be easily determined by using Formula 16. Formula 16 is one example of the relationship formula between the total size of the mixture and the size per particle of interest for determining the size to be sampled from the mixture. As described above, this relationship formula is derived based on the sum of the error from 0 of the degree of mixing Mₑ₀ in the completely separated state of the particles of interest and the error from 1 of the degree of mixing M_{R} in the completely mixed state of the particles of interest, the sum being a minimum or no greater than a threshold.

### [2-5] Selection Range for Sampling Volume

The method of determining the optimal sampling volume v for accurately measuring the mixing state has been described in [2-4]. However, for some products, the quality of the final product is not affected when the degree of mixing is within a given acceptable range. In such cases, it is not necessary for the sum of the error from 0 in the completely separated state Mₑ₀ and the error from 1 in the completely mixed state M_{R} to be minimum; it is sufficient that the sum is no greater than a given threshold. Therefore, by imparting a threshold Rᵥ to the error of the degree of mixing D_{M} in Formula 3 (in other words, the threshold Rᵥ imparted to the error of the degree of mixing D_{M}, which is the value obtained by subtracting the sum of the error from 0.0 in the completely separated state Mₑ₀ and the error from 1.0 in the completely mixed state M_{R} from 1), Formula 15 is converted to Formula 17.

$$\begin{matrix}[ Expression 17 ] & \\ 1 \to {M}_{r} + {M}_{e 0} \leq {R}_{v} & ( Formula 17 )\end{matrix}$$

The sufficient conditions for Formula 17 are assumed to be Formula 18.

$$\begin{matrix}[ Expression 18 ] & \\ ( 1 - {M}_{R} ) \leq \frac{{R}_{v}}{2} and {M}_{e 0} \leq \frac{{R}_{v}}{2} & ( Formula 18 )\end{matrix}$$

Rewriting Formula 18 in terms of the range of sampling volume v gives Formula 19. As expressed in Formula 19, the selection range of the size to be sampled from the mixture is expanded based on the total size of the mixture, the size per particle of interest, and the threshold Rᵥ for the allowable error range.

$$\begin{matrix}[ Expression 19 ] & \\ \frac{V}{1 + \frac{{R}_{v}^{2}}{4} ( \frac{V}{{V}_{PT}} - 1 )} \leq v \leq {R}_{v} V ( 1 - \frac{{R}_{v}}{4} ) provided that & ( Formula 19 )\end{matrix}$$

$${( 1 - {M}_{R} + {M}_{e 0} ) \vert}_{v = {v}_{opt}} < {R}_{v} < 1.$$

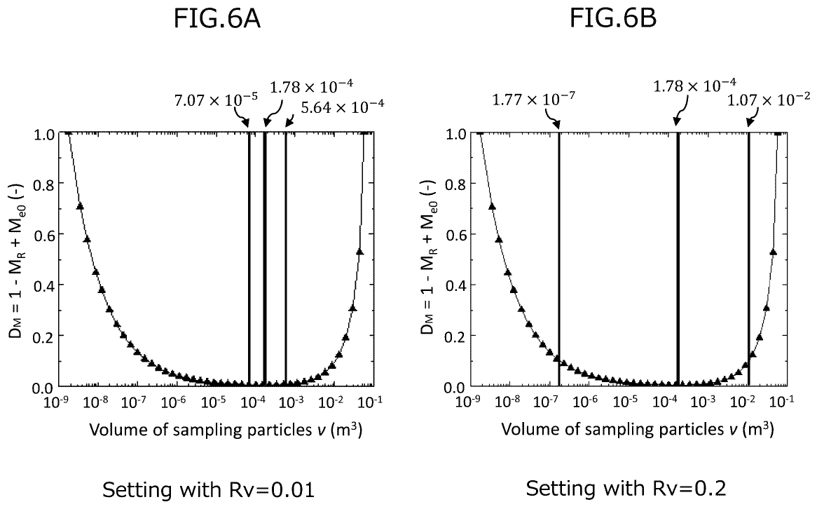

FIGS. 6A and 6B are graphs with the horizontal axis representing the sampling volume v and the vertical axis representing the error of the degree of mixing D_{M}, indicating the allowable range of the sampling volume v calculated based on Formula 19. The values substituted into the variables in Formula 19 are total volume V=5.65×10⁻² [m³], proportion Cᵢ of the particles of interest=P=0.5 [−], volume per particle of interest V_{PT}=1.77×10⁻⁹ [m³], optimal sampling volume v_{OPT}=1.78×10⁻⁴ [m³], and threshold Rᵥ=0.01 (FIG. 6A) and 0.2 (FIG. 6B).

FIG. 6A indicates the case where the threshold Rᵥ=0.01, with the allowable range of the sampling volume v being 7.07×10⁻⁵ to 5.64×10⁻⁴. FIG. 6B indicates the case where the threshold Rᵥ=0.2, with the allowable range of the sampling volume v being 1.77×10⁻⁷ to 1.07×10⁻².

By imparting the threshold Rᵥ to the error of the degree of mixing D_{M}, an allowable range can be imparted to the sampling volume to thereby expand the selection range of the sampling volume.

### [3] Determination of Number of Samplings

Hereinafter, the relationship between the number of samplings and the degree of mixing is discussed in Section [3-1], and the method of determining the number of samplings is discussed in Section [3-2].

### [3-1] Relationship Between Number of Samplings and Degree of Mixing

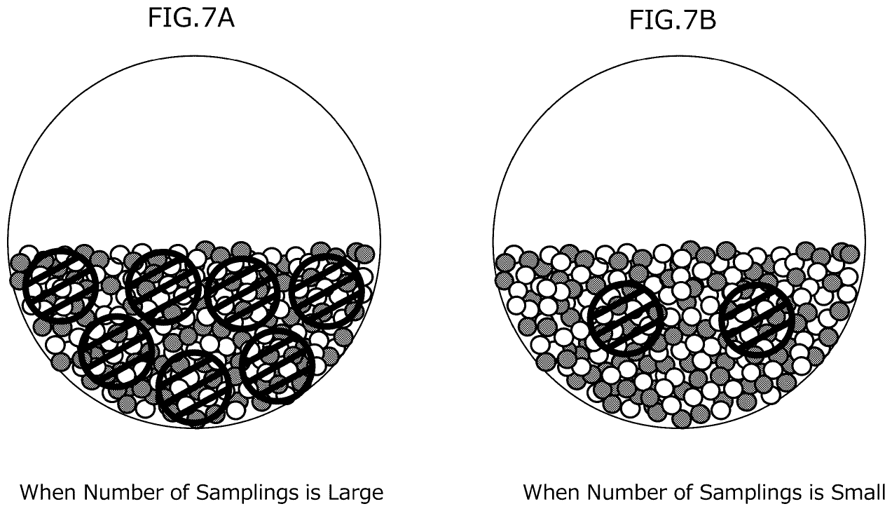

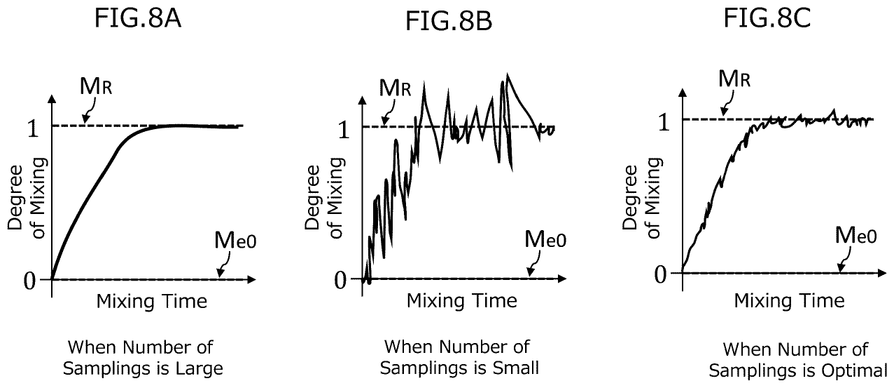

First, the relationship between the number of samplings Nₛ and the degree of mixing will be described with reference to FIGS. 7A to 8C. The conditions of the rolling rotary mixer illustrated in FIGS. 7A and 7B are the same as those in FIG. 1. Additionally, as in FIGS. 2A and 2B, the particles have two colors, namely, black and white, the volume per particle is the same, the numbers of particles are the same, and the particles of interest are white particles. The number of white small circles in the particle group represents the number of samplings, and the sampling volume v per sampling is the same.

FIGS. 8A to 8C are graphs with the horizontal axis representing mixing time and the vertical axis representing the degree of mixing M, with the thick solid line representing the degree of mixing M calculated based on Formulas 1 and 2 using samples taken a given number at each time. The degree of mixing takes a value between 0 and 1. Two horizontal lines are drawn in the graph, with the dashed line at the position of 0 on the vertical axis representing the degree of mixing Mₑ₀ and the dashed line at the position of 1 on the vertical axis representing the degree of mixing M_{R}.

When the number of samplings Nₛ is relatively large, as illustrated in FIG. 8A, the degree of mixing M is drawn as a single curve extending from the completely separated state to the completely mixed state. In this case, the mixing state can be measured accurately, but the measurement time cannot be shortened because the number of measurements is large. In contrast, when the number of samplings Nₛ is relatively small, as illustrated in FIG. 8B, the value of the degree of mixing varies significantly and the reliability is low. Thus, it can be understood that, in a graph with an optimal number of samplings Nₛ, as illustrated in FIG. 8C, the variation in the value of the degree of mixing is small and the curve is close to the ideal curve. In other words, the number of samplings Nₛ that can provide a degree of mixing with an arbitrary reliability is practical.

### [3-2] Method of Determining Number of Samplings

As discussed above, to calculate the number of samplings within a practical range, it is necessary to determine the range of the arbitrary reliability (confidence level). For this purpose, it is sufficient that the error between the population mean P of the proportion Cᵢ of the particles of interest in the particle groups sampled a given number of times Nₛ with a given sampling volume v and the mean of the proportion Cᵢ (C small i bar) of the particles of interest in the particle group sampled the given number of times Nₛ is within the range of ±R_{Ns}.

Assuming that the proportion Cᵢ of the particles of interest of each of the degree of mixing Mₑ₀ in the completely separated state and the degree of mixing M_{R} in the completely mixed state follows a normal distribution N(P, σ²), the standardized z of the proportion Cᵢ of the particles of interest is expressed by Formula 20.

$$\begin{matrix}[ Expression 20 ] & \\ z = \frac{{C}_{i} - P}{\sqrt{\frac{{N}_{s , max} - {N}_{s}}{{N}_{s , max} - 1}} \frac{σ}{\sqrt{{N}_{s}}}} [ {N}_{s , max} = \frac{V}{v} ] & ( Formula 20 )\end{matrix}$$

Here, since z follows the standard normal distribution N(0,1), the population mean P is within the range of Formula 21 when the confidence level is 1−α.

$$\begin{matrix}[ Expression 21 ] & \\ & ( Formula 21 )\end{matrix}$$

$$\text{?} - {z}_{1 - α} ( \sqrt{\frac{{N}_{s , max} - {N}_{s}}{{N}_{s , max} - 1}} \frac{σ}{\sqrt{N - s}} ) \leq P \leq \text{?} + {z}_{1 - α} ( \sqrt{\frac{{N}_{s , max} - {N}_{s}}{{N}_{s , max} - 1}} \frac{σ}{\sqrt{{N}_{s}}} )$$

$$\text{?} \text{indicates text missing or illegible when filed}$$

The variable in Formula 21 is the confidence coefficient at the confidence level (1−α) represented by z_{1-α}, specifically, z_{1-α} is the value on the horizontal axis of the standard normal distribution N(0,1) corresponding to the confidence level (1−α) (hereinafter referred to as the “upper value of the standard normal distribution”), in other words, the upper 100(1−α)% point of the standard normal distribution N(0,1).

The error between the population mean P of the proportion Cᵢ of the particles of interest in the particle groups sampled a given number of times Nₛ with a given sampling volume v and the mean (sample mean) of the proportion Cᵢ (C small i bar) of the particles of interest in the particle group sampled the given number of times Nₛ being within the range of ±R_{Ns} means that the z_{1-α} term of Formula 21 needs to be no greater than R_{Ns} as expressed in Formula 22.

$$\begin{matrix}[ Expression 22 ] & \\ {R}_{{N}_{s}} \geq {z}_{1 - α} ( \sqrt{\frac{{N}_{s , max} - {N}_{s}}{{N}_{s , max} - 1}} \frac{σ}{\sqrt{{N}_{s}}} ) & ( Formula 22 )\end{matrix}$$

Thus, the formula for calculating the minimum value of the number of samplings Nₛ is given by Formula 23.

$$\begin{matrix}[ Expression 23 ] & \\ {N}_{s} \geq \frac{{N}_{s , max} {σ}^{2}}{( {N}_{s , max} - 1 ) {( {R}_{{N}_{s}} / {z}_{1 - α} )}^{2} + {σ}^{2}} & ( Formula 23 )\end{matrix}$$

Assuming that the average standard deviation 6 of the proportion Cᵢ of the particles of interest in the entire mixing process is as expressed in Formula 24.

$$\begin{matrix}[ Expression 24 ] & \\ σ = ( {σ}_{e 0} + {σ}_{R} ) / 2 & ( Formula 24 )\end{matrix}$$

Formula 23 can be transformed into Formula 25.

$$\begin{matrix}[ Expression 25 ] & \\ {N}_{s} \geq \frac{{{N}_{s , max} ( {σ}_{e 0} + {σ}_{R} )}^{2}}{4 ( {N}_{s , max} - 1 ) {( {R}_{{N}_{s}} / {z}_{1 - α} )}^{2} + {( {σ}_{e 0} + {σ}_{R} )}^{2}} & ( Formula 25 )\end{matrix}$$

As expressed in Formula 25, the number of samplings sampled from the mixture is determined by the number of samplings N_{s,max} that can be sampled from any of the mixture using the size to be sampled (see Formula 6), the standard deviation σₑ₀ of the proportion of the particles of interest in the completely separated state when the number of samplings is maximized (N_{s,max}), the standard deviation σ_{R} of the proportion of the particles of interest in the completely mixed state when the number of samplings is maximized (N_{s,max}), the allowable error R_{Ns} for the population mean of the proportion of the particles of interest in the mixture and the sample mean of the proportion of the particles of interest in the mixture, and the upper value z_{1-α} of the standard normal distribution corresponding to the confidence level 1−α. By setting arbitrary values for the confidence coefficient z_{1-α}, at the confidence level (1−α) and the allowable error ±R_{Ns} in Formula 25, the number of samplings Nₛ within the range satisfying Formula 25 can be calculated.

### [4] Substitution of Variables

Although volume has so far been described as the sampling size as the sampling parameter, the above method can be applied to cases other than those where the target of sampling is a mixture having volume and a given volume is sampled. If the target of sampling is a two-dimensional planar image, the method of the present disclosure can be applied by treating the particles of interest as having areas. Similarly, if the target of sampling is a one-dimensional line segment, the present disclosure can be applied by treating the particles of interest as having lengths therein, and if the target of sampling is a group of particles, the present disclosure can be applied by treating the particles of interest as a numerical count. In those cases, the size of each sampling can be calculated in the same manner as volume by substituting the variables in Formulas 16 and 19 with the variables in Table 1.

Furthermore, in the calculation of the number of samplings Nₛ, the number of samplings Nₛ corresponding to each sampling size can be calculated by substituting the variables in Formulas 8, 13, and 25 with the variables in Table 1.

TABLE 1

| | | | | Proportion P |
|---|---|---|---|---|
| | | | Volume per | of volume of |
| Volume of | Sampling | Total | particle of | particle of |
| particles | volume v | volume V | interest V_{PT} | interest |
| Area of | Sampling | Total area S | Area per | Proportion P |
| particles | area s | | particle of | of area |
| | | | interest S_{PT} | |
| Length of | Sampling | Total length L | Diameter per | Proportion P |
| particles | length l | | particle of | of length |
| | | | interest L_{PT} | |
| Number of | Sampling | Total number N | 1 | Proportion P |
| particles | number n | | | of number |

By substituting the variables in Formula 16 with valuables in Table 1, Formula 26 is obtained for the optimal sampling area s_{OPT}, Formula 27 for the optimal sampling length l_{OPT}, and Formula 28 for the optimal sampling number n_{OPT}. As described above, Formulas 26 to 28 are examples of the relationship formula between the total size of the mixture and the size per particle of interest for calculating the size to be sampled from the mixture.

$$\begin{matrix}[ Expression 26 ] & \\ {s}_{OPT} = S {( \frac{{S}_{PT}}{S - {S}_{PT}} )}^{\frac{1}{3}} & ( Formula 26 )\end{matrix}$$

$$\begin{matrix}[ Expression 27 ] & \\ {l}_{OPT} = L {( \frac{{L}_{PT}}{L - {L}_{PT}} )}^{\frac{1}{3}} & ( Formula 27 )\end{matrix}$$

$$\begin{matrix}[ Expression 28 ] & \\ {n}_{OPT} = N {( \frac{1}{N - 1} )}^{\frac{1}{3}} & ( Formula 28 )\end{matrix}$$

Furthermore, by substituting the variables in Formula 19 with the variables in Table 1, Formula 29 is obtained for the sampling area s with an allowable range, Formula 30 for the sampling length l with an allowable range, and Formula 31 for the sampling number n with an allowable range. As expressed in Formulas 29 to 31, the selection range of the size to be sampled from the mixture is expanded based on the total size of the mixture, the size per particle of interest, and the threshold Rₛ, Rₗ, Rₙ for the allowable error range.

$$\begin{matrix}[ Expression 29 ] & \\ \frac{S}{1 + \frac{{R}_{s}^{2}}{4} ( \frac{S}{{S}_{PT}} - 1 )} \leq s \leq {R}_{s} S ( 1 - \frac{{R}_{s}}{4} ) & ( Formula 29 )\end{matrix}$$

$$provided that$$

$$( 1 - {M}_{R} + {M}_{e 0} ) {\vert}_{s = {s}_{opt}} < {R}_{s} < 1.$$

$$\begin{matrix}[ Expression 30 ] & \\ \frac{L}{1 + \frac{{R}_{l}^{2}}{4} ( \frac{L}{{L}_{PT}} - 1 )} \leq l \leq {R}_{l} L ( 1 - \frac{{R}_{l}}{4} ) & ( Formula 30 )\end{matrix}$$

$$provided that$$

$$( 1 - {M}_{R} + {M}_{e 0} ) {\vert}_{l = {l}_{opt}} < {R}_{l} < 1.$$

$$\begin{matrix}[ Expression 31 ] & \\ \frac{N}{1 + \frac{{R}_{n}^{2}}{4} ( N - 1 )} \leq n \leq {R}_{n} N ( 1 - \frac{{R}_{n}}{4} ) & ( Formula 31 )\end{matrix}$$

$$provided that$$

$$( 1 - {M}_{R} + {M}_{e 0} ) {\vert}_{n = {n}_{opt}} < {R}_{n} < 1.$$

Furthermore, by substituting the variables in Formula 8 with the variables in Table 1, the standard deviation σₑ₀ of the sample in the completely separated state is derived by Formula 32 for the sampling area s with an allowable range, Formula 33 for the sampling length l with an allowable range, and Formula 34 for the sampling number n with an allowable range. Formulas 32 to 34 are examples of the standard deviation used as the degree of mixing in the completely separated state.

$$\begin{matrix}[ Expression 32 ] & \\ {σ}_{e 0} = \sqrt{P ( 1 - P ) ( 1 - \frac{s}{S} )} & ( Formula 32 )\end{matrix}$$

$$\begin{matrix}[ Expression 33 ] & \\ {σ}_{e 0} = \sqrt{P ( 1 - P ) ( 1 - \frac{l}{L} )} & ( Formula 33 )\end{matrix}$$

$$\begin{matrix}[ Expression 34 ] & \\ {σ}_{e 0} = \sqrt{P ( 1 - P ) ( 1 - \frac{n}{N} )} & ( Formula 34 )\end{matrix}$$

Furthermore, by substituting the variables in Formula 13 with the variables in Table 1, the standard deviation σ_{R} of the sample in the completely mixed state is derived by Formula 35 for the sampling area s with an allowable range, Formula 36 for the sampling length l with an allowable range, and Formula 37 for the sampling number n with an allowable range. Formulas 35 to 37 are examples of the standard deviation σ_{R} used as the degree of mixing M_{R} in the completely mixed state.

$$\begin{matrix}[ Expression 35 ] & \\ {σ}_{R} = \sqrt{\frac{S - s}{S - {S}_{PT}} \frac{P ( 1 - P ) {S}_{PT}}{s}} & ( Formula 35 )\end{matrix}$$

$$\begin{matrix}[ Expression 36 ] & \\ {σ}_{R} = \sqrt{\frac{L - l}{L - {L}_{PT}} \frac{P ( 1 - P ) {L}_{PT}}{l}} & ( Formula 36 )\end{matrix}$$

$$\begin{matrix}[ Expression 37 ] & \\ {σ}_{R} = \sqrt{\frac{N - n}{N - 1} \frac{P ( 1 - P )}{n}} & ( Formula 37 )\end{matrix}$$

The present disclosure is applicable not only to volume but also to area, length, and number, as described above. Therefore, when an apparatus for analyzing images obtained with two-dimensional imaging images, line sensors, etc. is used, the degree of mixing can also be accurately determined with an appropriate number of images.

### [5] Configuration of Information Processing Apparatus

An information processing apparatus that performs the calculation processes of the present embodiment is embodied by a general-purpose computer that can execute a computer program 18 for the determination process described above (determination process of sampling size and number of samplings in the present embodiment).

### [5-1] Hardware Configuration of Information Processing Apparatus

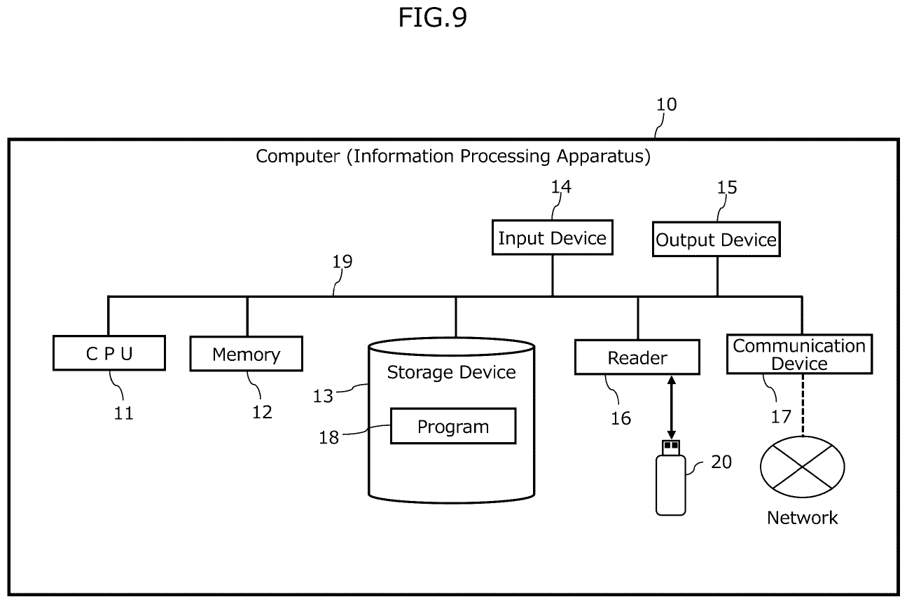

FIG. 9 is a block diagram schematically illustrating an example of the hardware configuration of an information processing apparatus 10 as an embodiment. The computer (information processing apparatus) 10 includes a CPU (processor, processor circuitry) 11 (central processing unit), a memory 12 (e.g., read only memory (ROM) and random access memory (RAM)), a storage device 13 (e.g., hard disk drive (HDD), solid state drive (SSD), optical drive, flash memory, or reader-writer), an input device 14 (e.g., keyboard and mouse), an output device 15 (e.g., display and printer), a reading device 16 (e.g., reader), and a communication device 17 (e.g., wireless or wired transceiver). These are communicably connected to each other via a bus 19 (e.g., control bus and data bus) provided inside the computer 10. The program (computer program) 18 is installed in the external storage device 13.

The computer program 18 may also be recorded on a recording medium 20 readable by an optical drive, flash memory, reader-writer, etc. Alternatively, the computer program 18 may be recorded on an online storage on a network to which the computer 10 is connectable. In any case, the computer program 18 can be executed by downloading it to the HDD, SSD, etc. of the computer 10 or by loading it into the CPU 11 and the memory 12.

The CPU 11 of the present embodiment reads the program installed in the external storage device 13 into the memory 12 and executes it, and outputs the calculation results to the output device 15. The data necessary for the determination process (e.g., total size of the mixture, size per particle of interest, and threshold of the allowable error range) is set based on an input from the input device 14 or as preset values. The data necessary for the determination process includes the total volume V of the mixture, the volume per particle of interest V_{PT}, the proportion P of the volume of particles of interest V_{PT} to the total volume V, the confidence coefficient z_{1-α}, and the allowable range of the number of samplings ±R_{Ns}.

### [5-2] Functional Configuration of Information Processing Apparatus

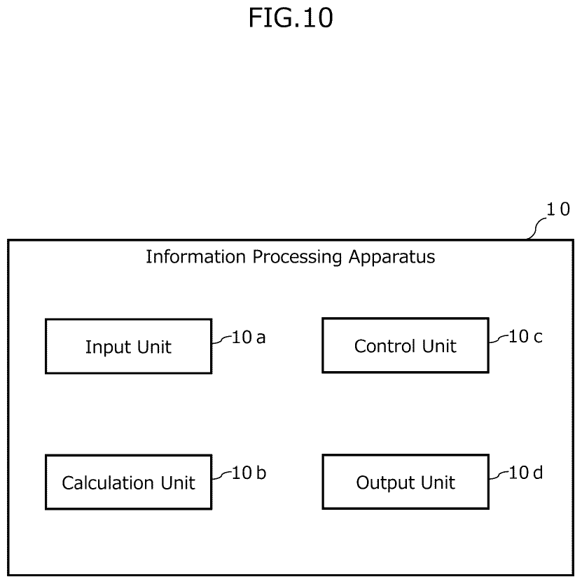

FIG. 10 is a block diagram schematically illustrating an example of the software configuration of the information processing apparatus 10 as an embodiment. The information processing apparatus 10 that performs the calculation processes described above includes an input unit 10a, a calculation unit 10b, a control unit 10c, and an output unit 10d. These elements may be implemented by electronic circuits (hardware), or the functions may be subdivided into multiple parts, some of which may be provided as hardware and others as software. The following description uses the case where the size is volume as an example.

The input unit 10a receives the total size of the mixture and the size per particle of interest. In other words, the input unit 10a receives information including the data necessary for the determination process (total volume V of the mixture, volume per particle of interest V_{PT}, proportion P of the volume of particles of interest V_{PT} to the total volume V, confidence coefficient z_{1-α}, and allowable range of the number of samplings ±R_{Ns}). The input unit 10a is embodied by the input device 14 of the information processing apparatus 10.

The calculation unit 10b determines the size to be sampled, from the total size of the mixture and the size per particle of interest, based on the method of determining the sampling size for determining the degree of mixing M of the particles of interest described above. The calculation unit 10b obtains the values based on the input from the input device 14 or obtains the preset values, and calculates the sampling volume v and the number of samplings Nₛ based on the method of determining the sampling volume v and the number of samplings Nₛ described above. The calculation unit 10b of the present embodiment obtains the total volume V of the mixture and the volume per particle of interest V_{PT}, and substitutes the obtained values into Formula 16 to determine the optimal sampling volume v_{OPT}.

In addition to the total volume V of the mixture and the volume per particle of interest V_{PT}, the calculation unit 10b also obtains the threshold Rᵥ if an error, etc., is allowed, and substitutes the obtained values into Formula 19 to determine the sampling volume v with an allowable range.

The calculation unit 10b may select a scale other than the volume listed in Table 1 to calculate the optimal sampling size. For example, the calculation unit 10b may obtain the total area S of the mixture and the area per particle of interest S_{PT}, and substitute the obtained values into Formula 26 to determine the optimal sampling area s_{OPT}. Or, the calculation unit 10b may obtain the total length L of the mixture and the particle diameter per particle of interest L_{PT}, and substitute the obtained values into Formula 27 to determine the optimal sampling length l_{OPT}. Alternatively, the calculation unit 10b may obtain the total number N of the mixture and substitute the obtained value into Formula 28 to determine the optimal sampling number n_{OPT}.

Similarly, if the sampling area s, the sampling length l, or the sampling number n with an allowable range is calculated, the calculation unit 10b may determine each value based on Formulas 29 to 31, respectively, by substituting the variables in Formula 19 with the variables in Table 1.

Furthermore, the calculation unit 10b obtains the proportion P of the volume of particles of interest V_{PT} to the total volume V, the confidence coefficient z_{1-α}, and the allowable range of the number of samplings ±R_{Ns}, and determines the number of samplings Nₛ within the range satisfying Formula 25 using Formula 25.

Similarly, if the number of samplings Nₛ for the area s, the number of samplings Nₛ for the length l, or the number of samplings Nₛ for the number n is calculated, the calculation unit 10b may determine each value by substituting the variables in Formulas 8, 13, and 25 with the variables in Table 1.

The calculation unit 10b stores the calculated optimal sampling volume v_{OPT} or sampling volume v and the number of samplings Nₛ in the external storage device 13.

Furthermore, the calculation unit 10b may determine the degree of mixing M of the particles of interest based on the determined size to be sampled and the number of samplings. Specifically, the calculation unit 10b performs sampling with the determined size to be sampled and the number of samplings, and calculates the degree of mixing M of the particles of interest using Formula 1 described above for the sample. The calculation unit 10b stores the determined degree of mixing M of the particles of interest in the external storage device 13. The calculation unit 10b is embodied by the CPU 11 of the information processing apparatus 10.

The control unit 10c will be described in a mixer described later.

The output unit 10d outputs the optimal sampling volume v_{OPT} or the sampling volume v and the number of samplings Nₛ, as well as the degree of mixing M of the particles of interest, calculated by the calculation unit 10b. The output unit 10d is embodied by the output device 15.

### [6] Operation Example

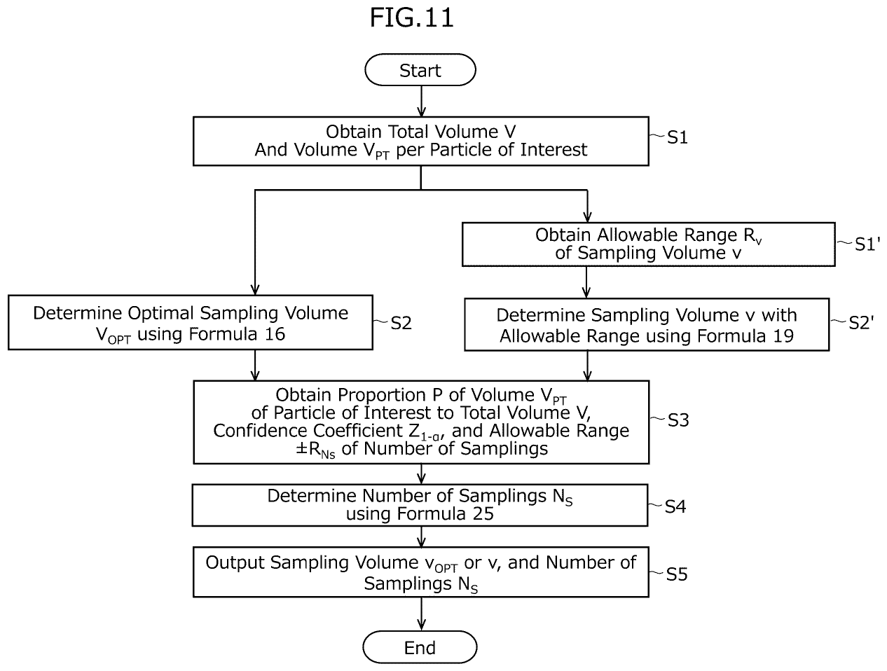

FIG. 11 is a flowchart illustrating the procedure when the computer 10 executes the computer program 18 (method of determining the sampling volume and the number of samplings of the present embodiment). As illustrated in FIG. 11, steps S1 and S1′ are initial setting steps for steps S2 and S2′. In this step S1, the data necessary for the determination process of the sampling volume (total volume V of the mixture and volume per particle of interest V_{PT}) is prepared or input from the external storage device 13, the input device 14, etc. The calculation unit 10b described above obtains the prepared or input values.

Furthermore, in step S1′, the threshold Rᵥ to be imparted to the error of the degree of mixing D_{M} is prepared or input from the input unit 10a (e.g., external storage device 13 or input device 14), as data necessary for the determination process of the sampling volume. The calculation unit 10b obtains the prepared or input values.

Step S2 is a step of determining the optimal sampling volume v_{OPT} as described above, and is implemented by the calculation unit 10b described above. In step S2, the total volume V of the mixture and the volume per particle of interest V_{PT} obtained in step S1 are substituted into Formula 16 to calculate the optimal sampling volume v_{OPT}. As described above, Formula 16 is derived from Formula 15, which calculates the sum of the error from 0 in the completely separated state Mₑ₀ and the error from 1 in the completely mixed state M_{R}, and indicates that the sum is minimized.

Step S2′ is a step of determining the sampling volume v with an allowable range as described above, and is implemented by the calculation unit 10b. In step S2′, the total volume V of the mixture and the volume per particle of interest V_{PT} obtained in step S1, and the threshold Rᵥ to be imparted to the error of the degree of mixing D_{M} obtained in step S1′ are substituted into Formula 19 to calculate the sampling volume v with an allowable range. As described above, Formula 19 is derived from the sufficient conditions for Formula 17, which calculates the sum of the error from 0 in the completely separated state Mₑ₀ and the error from 1 in the completely mixed state M_{R}, and indicates that the sum is no greater than the threshold Rᵥ.

Step S3 is an initial setting step for step S4. In step S3, the data necessary for the determination process of the number of samplings (proportion P of the volume of particles of interest V_{PT} to the total volume V, confidence coefficient z_{1-α}, and allowable range of the number of samplings ±R_{Ns}) is prepared or input from the input unit 10a (e.g., external storage device 13 or input device 14). The calculation unit 10b obtains the prepared or input values.

Step S4 is a step of determining the number of samplings Nₛ described above, and is implemented by the calculation unit 10b. In step S4, the proportion P of the volume of particles of interest V_{PT} to the total volume V, the confidence coefficient z_{1-α}, and the allowable range of the number of samplings ±R_{Ns} obtained in step S3 are substituted into Formula 25 to calculate the practical number of samplings Nₛ. Furthermore, the calculation unit 10b may store the optimal sampling volume v_{OPT} or the sampling volume v and the number of samplings Nₛ in the external storage device 13.

In step S5, the output unit 10d outputs the optimal sampling volume v_{OPT} or the sampling volume v and the number of samplings Nₛ, and the flow ends.

### [7] Configuration of Mixer

The information processing apparatus 10 that performs the calculation processes of the present embodiment may be incorporated into a mixer. In other words, the computer program 18 for the determination process described above (determination process of the sampling size and the number of samplings of the present embodiment) may be executed as part of the entire mixing process in the information processing apparatus (computer) 10 in the mixer. The information processing apparatus 10 incorporated into the mixer controls the rotation of the drum (mixing operation) based on the calculated values. The following primarily describes the control of the mixing operation. Note that the same reference numerals as those used in the description of the information processing apparatus 10 are used for the same or similar elements. The following description uses the case where the size is volume as an example.

### [7-1] Hardware Configuration of Mixer

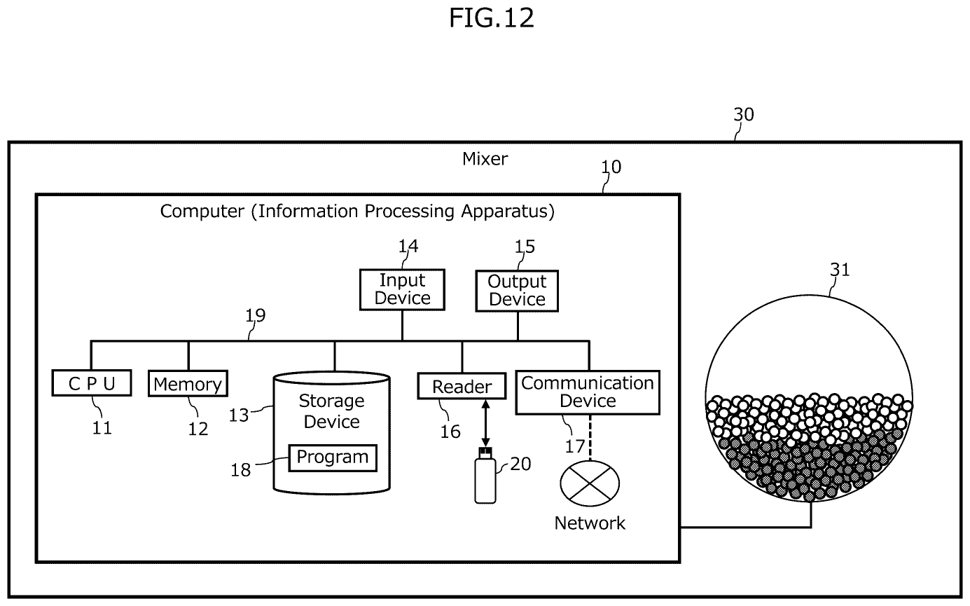

FIG. 12 is a block diagram schematically illustrating an example of the hardware configuration of the mixer 30 as an embodiment. One example of the mixer 30 is a rolling rotary mixer, but this is not limiting. The mixer 30 of the present embodiment includes the information processing apparatus 10 and a drum 31.

The input device 14 of the information processing apparatus 10 receives the data necessary for the processes of the present embodiment. The input device 14 may also receive data necessary for the rotation of the drum 31.

The CPU 11 of the information processing apparatus 10 determines the size to be sampled (optimal sampling size or sampling size within the selection range corresponding to the allowable degree of mixing) and the number of samplings. The CPU 11 also determines the degree of mixing M of the particles of interest based on the determined size to be sampled and the number of samplings. Furthermore, the CPU 11 controls the rotation of the drum 31 according to the determined degree of mixing.

The drum 31 performs rolling rotation to mix the target to be mixed (hereinafter also referred to as the target) containing the particles of interest fed therein. The drum 31 performs rolling rotation according to the input from the input device 14 or values set as the preset values and the determined degree of mixing M.

### [7-2] Software Configuration of Mixer

An example of the software configuration of the mixer 30 as an embodiment is the same as the example of the configuration illustrated in FIG. 10. Similar to the software configuration of the information processing apparatus 10, the mixer 30 includes an input unit 10a, a calculation unit 10b, a control unit 10c, and an output unit 10d.

The input unit 10a receives the necessary data. The calculation unit 10b determines the size to be sampled and the number of samplings based on the necessary data input from the input unit 10a. Furthermore, after the drum 31 has mixed the target for a given time, the calculation unit 10b determines the degree of mixing M of the particles of interest based on the determined size to be sampled and the number of samplings, as well as other necessary information.

The control unit 10c performs mixing according to the degree of mixing M of the particles of interest based on the size to be sampled determined by the calculation unit 10b. After the drum 31 has mixed the target for a given time, the control unit 10c controls the rotation (mixing operation) of the drum 31 according to the degree of mixing M of the particles of interest determined by the calculation unit 10b. The control unit 10c is embodied by the CPU 11 of the information processing apparatus 10.

The control unit 10c may determine the degree of completion of the mixing of the target based on the degree of mixing M determined by the calculation unit 10b. If the degree of mixing M of the target reaches the desired degree of mixing, the control unit 10c determines that the mixing is complete and ends the mixing operation. On the other hand, if the degree of mixing M of the target does not reach the desired degree of mixing, the control unit 10c determines that the mixing is incomplete and resumes the mixing operation. The control unit 10c continues the mixing operation for a given time according to the degree of completion of the mixing.

The output unit 10d outputs the values determined by the calculation unit 10b and the control unit 10c.

Upon controlling the mixing operation in the drum 31, the mixing conditions are set either by using, by the computer program 18, data created with general-purpose software or through inputs from the input device 14.

Also, upon performing a mixing simulation, various conditions are set by using, by the computer program 18, data created with general-purpose software or through inputs from the input device 14, so that the information processing apparatus 10 that performs the calculation processes can be used to accurately carry out the simulation.

### [8] Effects

(1) In the method of determining the degree of mixing of particles, the program 18, the information processing apparatus 10, and the mixer 30 described above, the size to be sampled from the mixture is calculated and determined from the relationship formula between the total size of the mixture and the size per particle of interest. This allows the optimal sampling size to be easily calculated based on the total size and the size per particle of interest, which are measurable values.

(2) When the sampling size is volume v, the optimal sampling volume v_{OPT} is determined using Formula 16 where V is the volume of the mixture and V_{PT} is the volume of the particles of interest, derived from Formula 15, which indicates that the sum is minimized. This allows the optimal sampling volume v_{OPT} to be easily calculated based on the total volume V and the volume of the particles of interest V_{PT}, which are measurable values.

Similarly, when the sampling size is area s, the optimal sampling area s_{OPT} is determined using Formula 26 where S is the total area of the mixture and S_{PT} is the particle area of the particles of interest, derived from Formula 15, which indicates that the sum is minimized. This allows the optimal sampling area s_{OPT} to be easily calculated based on the total area S, which is a measurable value.

Similarly, when the sampling size is length l, the optimal sampling length l_{OPT} is determined using Formula 27 where L is the total length of the mixture and L_{PT} is the particle diameter of the particles of interest, derived from Formula 15, which indicates that the sum is minimized. This allows the optimal sampling length l_{OPT} to be easily calculated based on the total length L, which is a measurable value.

Similarly, when the sampling size is the number of particles n, the optimal sampling number n_{OPT} is determined using Formula 28 where N is the total number of particles in the mixture, derived from Formula 15, which indicates that the sum is minimized. This allows the optimal sampling number n_{OPT} to be easily calculated based on the total size N which is a measurable value.

(3) The relationship formulas used in the method of determining the degree of mixing of particles, the program 18, the information processing apparatus 10, and the mixer 30 described above are derived based on the sum of the error from 0 of the degree of mixing Mₑ₀ in the completely separated state of the particles of interest in the mixture and the error from 1 of the degree of mixing M_{R} in the completely mixed state of the particles of interest, the sum being the minimum of 0 or no greater than the threshold Rᵥ. This allows for the determination of the optimal value of the size for sampling a portion of the mixture when the sum is at the minimum of 0. If the sum is no greater than the threshold Rᵥ, it allows for the determination of the value of the size to be sampled of a portion of the mixture with an acceptable range.

(4) The standard deviation σₑ₀ when the total size of any of the mixture is divided by the sampling size and the number of samplings is maximized (N_{s,max}) is used as the degree of mixing Mₑ₀ in the completely separated state. This allows the relationship of the degree of mixing Mₑ₀ in the completely separated state to the size for sampling a portion of the mixture to be expressed in a relationship formula.

(5) The standard deviation σ_{R} when the total size of any of the mixture is divided by the sampling size and the number of samplings is maximized (N_{s,max}) is used as the degree of mixing M_{R} in the completely mixed state. This allows the relationship of the degree of mixing M_{R} in the completely mixed state to the parameter for sampling a portion of the mixture (sampling volume v) to be expressed in a relationship formula.

(6) The selection range of the sampling size can be expanded by using the total size of the mixture, the size per particle of interest, and the threshold of the allowable error range. This allows an allowable range to be imparted to the sampling size. Imparting an allowable range to the sampling size gives a degree of freedom with assured reliability to the sampling volume according to the desired degree of mixing.

(7) When the sampling size is volume, the sampling volume v with an allowable range is selected from the range determined by Formula 19 where V is the total volume of the mixture, Vₚₜ is the volume per particle of interest, and Rᵥ is the threshold. Imparting an allowable range Rᵥ to the sampling volume v gives a degree of freedom with assured reliability to the sampling volume v according to the desired degree of mixing.

When the sampling size is area, the sampling area s with an allowable range is selected from the range determined by Formula 29 where S is the total area of the mixture, S_{PT} is the particle area of the particles of interest, and Rₛ is the threshold. Imparting an allowable range Rₛ to the sampling area s gives a degree of freedom with assured reliability to the sampling area s according to the desired degree of mixing.

When the sampling size is length, the sampling length l with an allowable range is selected from the range determined by Formula 30 where L is the total length of the mixture, L_{PT} is the particle diameter of the particles of interest, and Rₗ is the threshold. Imparting an allowable range Rₗ to the sampling length l gives a degree of freedom with assured reliability to the sampling length l according to the desired degree of mixing.

When the sampling size is the number of particles, the sampling number n with an allowable range is selected from the range determined by Formula 31 where N is the total number of particles in the mixture and Rₙ is the threshold. Imparting an allowable range Rₙ to the sampling number n allows the sampling number n to be calculated according to the desired degree of mixing.

(8) The number of samplings Nₛ is determined by Formula 25 where N_{s,max} is the number of samplings that can be sampled from any of the mixture using the sampling size, σ_{ε0} is the standard deviation of the number of particles of interest in the completely separated state Mₑ₀ when the number of samplings is maximized (N_{s,max}), σ_{R} is the standard deviation of the number of particles of interest in the completely mixed state M_{R} when the number of samplings is maximized (N_{s,max}), R_{Ns} is the error between the population mean of the proportion P of the particles of interest in the mixture and the sample mean Cᵢ (C small i bar), and z_{1-α} is the upper value of the standard normal distribution (condition of Formula 21). Since the allowable error R_{N}s and the confidence coefficient z_{1-α} can be arbitrarily set, the number of samplings Nₛ according to the desired degree of mixing can be determined within the range satisfying Formula 25 by setting appropriate values to the allowable error ±R_{Ns} and the confidence coefficient z_{1-α} at the confidence level (1−α).

(9) The mixer 30 includes the input unit 10a that receives the total size of the mixture and the size per particle of interest, the calculation unit 10b that determines the sampling size and the number of samplings from the received total size of the mixture and size per particle of interest based on the present disclosure, and the control unit 10c that performs mixing according to the degree of mixing of the particles of interest based on the determined sampling size and number of samplings. The mixer 30 of the present disclosure provides a highly reliable degree of mixing, resulting in the provision of highly reliable products.

As described above, since the method of determining the degree of mixing of particles of interest in a mixture containing the particles of interest, the program 18, the information processing apparatus 10, and the mixer according to the present embodiment can accurately determine the sampling volume and the number of samplings for measuring the degree of mixing of the particles of interest in the mixture according to the desired degree of mixing, the accuracy of quality control of the final product including the mixture as a constituting element is improved.

### [9] Miscellaneous

The disclosed technology is not limited to the above-described embodiment, and various modifications can be made without departing from the spirit of the present embodiment. Each element and process of the present embodiment can be selectively adopted or appropriately combined as necessary.

Although the description has been made with reference to the example of mixing two types of particles in the present embodiment, the method described above can be applied to cases where there are more than two types of particles, because the particles of interest can be considered separately from the others.

Although the particles of interest have been described as spheres in the present embodiment as an example, their shape is not limited to spheres as long as they are a solid substance. When the particle diameter is used as the sampling size, the particles may have any shape as long as the particle diameter can be defined. In this manner, the apparatus, the method, and the program of the present embodiment can be applied to all industrial fields in which solid particles of interest are mixed.

All examples and conditional language recited herein are intended for the pedagogical purposes of aiding the reader in understanding the disclosure and the concepts contributed by the inventor to further the art, and are not to be construed limitations to such specifically recited examples and conditions, nor does the organization of such examples in the specification relate to a showing of the superiority and inferiority of the disclosure. Although one or more embodiments of the present disclosures have been described in detail, it should be understood that the various changes, substitutions, and alterations could be made hereto without departing from the spirit and scope of the disclosure.

### [10] Appendix

With regard to the above embodiment, the following appendix is further disclosed.

### (Appendix 1)

An information processing apparatus comprising:
a memory; and
a processor coupled to the memory, the processor being configured to:
obtain a total size of the mixture and a size per particle of interest;
determine a size to be sampled from the mixture based on a relationship formula between the total size of the mixture and the size per particle of interest; and
perform mixing according to the degree of mixing of the particles of interest based on the size to be sampled determined.

What is claimed is:

1. A computer-implemented method of determining a degree of mixing of particles of interest, comprising:
for determining the degree of mixing of the particles of interest from a mixture containing the particles of interest,
calculating and determining a size to be sampled from the mixture based on a relationship formula between a total size of the mixture and a size per particle of interest.

2. The method of determining the degree of mixing of the particles of interest according to claim 1,
wherein the relationship formula is:
the following formula A when the size is a sampling volume v,
the following formula B when the size is a sampling area s,
the following formula C when the size is a sampling length l, or
the following formula D when the size is a number n:
$$\begin{matrix}[ Expression 1 ] & \\ {v}_{OPT} = V {( \frac{{V}_{PT}}{V - {V}_{PT}} )}^{\frac{1}{3}} & ( Formula A )\end{matrix}$$
(V is a total volume of the mixture and V_{PT} is a volume per particle of the particles of interest),
$$\begin{matrix}[ Expression 2 ] & \\ {s}_{OPT} = S {( \frac{{S}_{PT}}{S - {S}_{PT}} )}^{\frac{1}{3}} & ( Formula B )\end{matrix}$$
(S is a total area of the mixture and S_{PT} is a particle area per particle of the particles of interest),
$$\begin{matrix}[ Expression 3 ] & \\ {l}_{OPT} = L {( \frac{{L}_{PT}}{L - {L}_{PT}} )}^{\frac{1}{3}} & ( Formula C )\end{matrix}$$
(L is a total length of the mixture and L_{PT} is a particle diameter per particle of the particles of interest), and
$$\begin{matrix}[ Expression 4 ] & \\ {n}_{OPT} = N {( \frac{1}{N - 1} )}^{\frac{1}{3}} & ( Formula D )\end{matrix}$$
(N is a total number of particles contained in the mixture).

3. The method of determining the degree of mixing of the particles of interest according to claim 1,
wherein the relationship formula is
derived based on a sum of an error from a degree of mixing of 0 in a completely separated state of the particle of interest and an error from a degree of mixing of 1 in a completely mixed state of the particles of interest, the sum being a minimum or no greater than a threshold.

4. The method of determining the degree of mixing of the particles of interest according to claim 3,
wherein a standard deviation when a total size of any of the mixture is divided by the size and the number of samplings is maximized is used as the degree of mixing in the completely separated state.

5. The method of determining the degree of mixing of the particles of interest according to claim 4,
wherein the standard deviation used as the degree of mixing in the completely separated state is:
derived from the following formula E when the size is the sampling volume v,
derived from the following formula F when the size is the sampling area s,
derived from the following formula G when the size is the sampling length l, or
derived from the following formula H when the size is the number n:
$$\begin{matrix}[ Expression 5 ] & \\ {σ}_{e 0} = \sqrt{P ( 1 - P ) ( 1 - \frac{v}{V} )} & ( Formula E )\end{matrix}$$
(V is the total volume of the mixture and P is a proportion of the particles of interest in the total volume V of the mixture),
$$\begin{matrix}[ Expression 6 ] & \\ {σ}_{e 0} = \sqrt{P ( 1 - P ) ( 1 - \frac{s}{S} )} & ( Formula F )\end{matrix}$$
(S is the total area of the mixture and P is a proportion of the particles of interest in the total area S of the mixture),
$$[ Expression 7 ]$$
$${σ}_{e 0} = \sqrt{P ( 1 - P ) ( 1 - \frac{l}{L} )} \qquad ( Formula G )$$
(L is the total length of the mixture and P is a proportion of the particles of interest in the total length L of the mixture), and
$$[ Expression 8 ]$$
$$\begin{matrix}{σ}_{e 0} = \sqrt{P ( 1 - P ) ( 1 - \frac{n}{N} )} & ( Formula H )\end{matrix}$$
(N is the total number of particles contained in the mixture and P is a proportion of the particles of interest in the total number N of the mixture).

6. The method of determining the degree of mixing of the particles of interest according to claim 3,
wherein the standard deviation when the total size of any of the mixture is divided by the size and the number of samplings is maximized is used as the degree of mixing in the completely mixed state.

7. The method of determining the degree of mixing of the particles of interest according to claim 6,
wherein the standard deviation used as the degree of mixing in the completely mixed state is:
derived from the following formula I when the size is the sampling volume v,
derived from the following formula J when the size is the sampling area s,
derived from the following formula K when the size is the sampling length l, or
derived from the following formula L when the size is the number n:
$$[ Expression 9 ]$$
$${σ}_{R} = \sqrt{\frac{V - v}{V - {V}_{PT}} \frac{P ( 1 - P ) {V}_{PT}}{v}} \qquad ( Formula I )$$
(V is the total volume of the mixture, V_{PT} is the volume per particle of the particles of interest, P is the proportion of the particles of interest in the total volume V of the mixture),
$$[ Expression 10 ]$$
$${σ}_{R} = \sqrt{\frac{S - s}{S - {S}_{PT}} \frac{P ( 1 - P ) {S}_{PT}}{s}} \qquad ( Formula J )$$
(S is the total area of the mixture, S_{PT} is the particle area per particle of the particles of interest, and P is the proportion of the particles of interest in the total area S of the mixture),
$$[ Expression 11 ]$$
$${σ}_{R} = \sqrt{\frac{L - l}{L - {L}_{PT}} \frac{P ( 1 - P ) {L}_{PT}}{l}} \qquad ( Formula K )$$
(L is the total length of the mixture, L_{PT} is the particle diameter per particle of the particles of interest, and P is the proportion of the particles of interest in the total length L of the mixture), and
$$[ Expression 12 ]$$
$${σ}_{R} = \sqrt{\frac{N - n}{N - 1} \frac{P ( 1 - P )}{n}} \qquad ( Formula L )$$
(N is the total number of particles contained in the mixture and P is the proportion of the particles of interest in the total number N of the mixture).

8. The method of determining the degree of mixing of the particles of interest according to claim 1, comprising
expanding a selection range of the size to be sampled from the mixture based on the total size of the mixture, the size per particle of interest, and a threshold of an allowable error range.

9. The method of determining the degree of mixing of the particles of interest according to claim 1,
wherein the selection range of the size to be sampled from the mixture is determined by:
the following formula M where the threshold is represented by Rᵥ when the size is the sampling volume v,
the following formula N where the threshold is represented by Rₛ when the size is the sampling area s,
the following formula O where the threshold is represented by Rₗ when the size is the sampling length l, or
the following formula P where the threshold is represented by Rₙ when the size is the number n:
$$[ Expression 13 ]$$
$$\frac{V}{1 + \frac{{R}_{v}^{2}}{4} ( \frac{V}{{V}_{PT}} - 1 )} \leq v \leq {R}_{v} V ( 1 - \frac{{R}_{v}}{4} ) \qquad ( Formula M )$$
(V is the total volume of the mixture and V_{PT} is the volume per particle of the particles of interest),
$$[ Expression 14 ]$$
$$\frac{S}{1 + \frac{{R}_{s}^{2}}{4} ( \frac{S}{{S}_{PT}} - 1 )} \leq s \leq {R}_{s} S ( 1 - \frac{{R}_{s}}{4} ) \qquad ( Formula N )$$
(S is the total area of the mixture and S_{PT} is the particle area per particle of the particles of interest),
$$[ Expression 15 ]$$
$$\frac{L}{1 + \frac{{R}_{l}^{2}}{4} ( \frac{L}{{L}_{PT}} - 1 )} \leq l \leq {R}_{l} L ( 1 - \frac{{R}_{l}}{4} ) \qquad ( Formula O )$$
(L is the total length of the mixture and L_{PT} is the particle diameter per particle of the particles of interest), and
$$[ Expression 16 ]$$
$$\frac{N}{1 + \frac{{R}_{n}^{2}}{4} ( N - 1 )} \leq n \leq {R}_{n} N ( 1 - \frac{{R}_{n}}{4} ) \qquad ( Formula P )$$
(N is the total number of particles contained in the mixture).

10. The method of determining the degree of mixing of the particles of interest according to claim 1,
wherein the number of samplings sampled from the mixture is determined based on:
a number of samplings that can be sampled from any of the mixture using the sampling size,
the standard deviation when the number of samplings is maximized regarding a proportion of the particles of interest in the completely separated state,
the standard deviation when the number of samplings is maximized regarding a proportion of the particles of interest in the completely mixed state,
an allowable error between a population mean and a sample mean of a proportion of the particles of interest in the mixture, and
an upper value of a standard normal distribution corresponding to a confidence level 1−α.

11. The method of determining the degree of mixing of the particles of interest according to claim 10,
wherein, when the number of samplings that can be sampled is represented by N_{s,max},
the standard deviation when the number of samplings is maximized regarding the proportion of the particles of interest in the completely separated state is represented by σₑ₀,
the standard deviation when the number of samplings is maximized regarding the proportion of the particles of interest in the completely mixed state is represented by a,
an error between the population mean and the sample mean of the proportion of the particles of interest in the mixture is represented by R_{Ns}, and
the upper value of the standard normal distribution corresponding to the confidence level 1−α is represented by z_{1-α},
the number of samplings is determined from the following formula Q:
$$[ Expression 17 ]$$
$${N}_{s} \geq \frac{{{N}_{s , max} ( {σ}_{e 0} + {σ}_{R} )}^{2}}{4 ( {N}_{s , max} - 1 ) {( {R}_{{N}_{s}} / {z}_{1 - a} )}^{2} + {( {σ}_{e 0} + {σ}_{R} )}^{2}} \qquad ( Formula Q )$$
where σₑ₀ is derived by the following expression 18 and σ_{R} is derived by the following expression 19 when the size is the sampling volume v:
$${σ}_{e 0} = \sqrt{P ( 1 - P ) ( 1 - \frac{v}{V} )} \qquad [ Expression 18 ]$$
$${σ}_{R} = \sqrt{\frac{V - v}{V - {V}_{PT}} \frac{P ( 1 - P ) {V}_{PT}}{v}} \qquad [ Expression 19 ]$$
(V is the total volume of the mixture, v is the volume to be sampled, V_{PT} is the volume per particle of the particles of interest, and P is the proportion of the particles of interest in the total volume V of the mixture),
σₑ₀ is derived by the following expression 20 and σ_{R} is derived by the following expression 21 when the size is the sampling area s:
$${σ}_{e 0} = \sqrt{P ( 1 - P ) ( 1 - \frac{s}{S} )} \qquad [ Expression 20 ]$$
$${σ}_{R} = \sqrt{\frac{S - s}{S - {S}_{PT}} \frac{P ( 1 - P ) {S}_{PT}}{s}} \qquad [ Expression 21 ]$$
(S is the total area of the mixture, s is the area to be sampled, S_{PT} is the particle area per particle of the particles of interest, and P is the proportion of the particles of interest in the total area S of the mixture),
σₑ₀ is derived by the following expression 22 and σR is derived by the following expression 23 when the size is the sampling length l:
$${σ}_{e 0} = \sqrt{P ( 1 - P ) ( 1 - \frac{l}{L} )} \qquad [ Expression 22 ]$$
$${σ}_{R} = \sqrt{\frac{L - l}{L - {L}_{PT}} \frac{P ( 1 - P ) {L}_{PT}}{l}} \qquad [ Expression 23 ]$$
(L is the total length of the mixture, l is the length to be sampled, L_{PT} is the particle diameter per particle of the particles of interest, and P is the proportion of the particles of interest in the total length L of the mixture), or
σₑ₀ is derived by the following expression 24 and σ_{R} is derived by the following expression 25 when the size is the sampling number n:
$${σ}_{e 0} = \sqrt{P ( 1 - P ) ( 1 - \frac{n}{N} )} \qquad [ Expression 24 ]$$
$${σ}_{R} = \sqrt{\frac{N - n}{N - 1} \frac{P ( 1 - P )}{n}} \qquad [ Expression 25 ]$$
(N is the total number of particles contained in the mixture, n is the number to be sampled, and P is the proportion of the particles of interest in the total number N of the mixture).

12. A non-transitory computer-readable recording medium having one or more executable instructions stored thereon, which, when executed by processor circuitry, cause the processor circuitry to perform the method according to claim 1.

13. An information processing apparatus comprising:
a memory; and
processor circuitry coupled to the memory, wherein
the memory includes the non-transitory computer-readable recording medium according to claim 12.

14. A mixer comprising:
a memory; and
processor circuitry coupled to the memory, the processor circuitry being configured to:
obtain a total size of a mixture and a size per particle of interest;
determine a size to be sampled from the mixture based on a relationship formula between the total size of the mixture and the size per particle of interest; and
mix according to the degree of mixing of the particles of interest based on the determined size to be sampled.
